(19) United States
(12) Patent Application Publication
(10) Pub. No.: US 2006/0016061 A1
(43) Pub. Date: Jan. 26, 2006

(54) Kinematic mounting system

(76) Inventor: Gad Shelef, Palo Alto, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/898,595

(22) Filed: Jul. 22, 2004

(51) Int. Cl. B23Q 3/00; F16M 13/00

(52) U.S. Cl. 29/464; 248/562

(57) ABSTRACT

The kinematic mounting system includes a first component, a second component, and at least one connector. The first component defines at least one cavity therein, while the second component defines at least one groove therein. The connector includes a first surface and a second surface. The first surface is configured to press-fit within the cavity defined by the first component. The second surface is coupled to the first surface and is configured to contact the groove of the second component along two substantially parallel contact lines, while the first and second components come to a tight contact in their interface. The first and second components may be an engine block and an engine bedplate.

### BACKGROUND OF THE INVENTION

1. Field of the Invention

The present invention relates generally to kinematic mounts and particularly to a kinematic mounting system for repeatedly aligning two components with one another, such as engine block and engine bedplate components of a combustion engine.

2. Description of Related Art

Kinematic mounts, otherwise known as kinematic couplings or restraints, are commonly used to couple measuring equipment or instruments to a base or substructure, where despite repeated disassembly and reassembly the components remain in the same relative position to one another as when previously assembled.

Examples of such instruments include: precision instruments, such as optical elements like lenses mirrors, prisms, telescopes, cameras, lasers or sensors; sensitive measuring equipment; strain sensitive devices; lithography equipment, such as projection optics; instruments that are disassembled and moved frequently so that a permanent support is not suitable; and engines, such as the engine block and bedplate components of a combustion engine that are typically disassembled and reassembled multiple times during manufacture and maintenance of the engine.

Indeed, very small changes in the position of such instruments can make a substantial difference in the accuracy of results obtained from the instrument. Accordingly, kinematic mounts were developed to address such precise repeated assembly.

According to well-known principles, for a rigid body to be completely fixed in space, despite repeated disassembly and reassembly, all six degrees of freedom need to be constrained. In other words, three translations and three rotations must be constrained with respect to some arbitrary fixed coordinate system. A mount is said to be kinematic when all six degrees of freedom are constrained without any additional constraints, i.e., any additional constraints would be redundant. A kinematic mount therefore has six independent constraints.

One well-known kinematic mount includes a fixed base plate which has three V-shaped grooves formed therein. Each groove forms an angle of approximately 120 degrees with each other groove, and the walls of each groove form angles of approximately 45 degrees with the surface of the base plate. On a second plate, three convex spherical members are secured roughly in an equilateral triangular array. When the second plate is rested upon the first plate, each of the three convex spherical members rests within one of the three grooves, contacting the two side walls of each respective groove at two point contacts. Any instrument secured to the second plate, which may be lifted from the base plate and, when replaced, will occupy the identical position relative to the base, which normally remains fixed.

However, the above described point contacts between each spherical member and a respective groove leads to concentrated forces at these contact points. These concentrated forces generate high stresses, known as Hertzian stresses, both at the spherical member and at the groove.

The above described mount, while being sufficient for light loads, such as laboratory applications or light-duty field applications, fails in heavy-duty applications, such as between the various components in an automobile engine which are often disassembled and reassembled during manufacture or maintenance.

In light of the above it is highly desirable to provide a kinematic mounting system that addresses the high stresses generated by point contacts, while still providing a kinematic mount, as described above.

### SUMMARY OF THE INVENTION

According to the invention there is provided a kinematic mounting system for repeatedly coupling two components together. The kinematic mounting system includes a first component defining at least one first aperture therein, a second component defining at least one second aperture therein, and at least one connector. The connector includes first and second surfaces coupled to and substantially opposing one another. The first surface is press-fit within the first aperture defined by the first component. The second surface contacts the second component within the second aperture along at least one contact line.

In some embodiments, the second surface contacts the second component within the second aperture along at least two substantially parallel contact lines. Alternatively, the second surface contacts the second component at the second aperture along an annular contact line. In some embodiments, the second surface contacts the second component at the second aperture only along the at least one contact line.

In some embodiments, the first surface may define an at least partial hemispherical surface, where the first aperture is an at least partially cylindrical cavity. Alternatively, the second surface may define an at least partial half-cylindrical surface, where the second aperture is an at least partial a frusto-triangular prism groove.

In other embodiments, the second surface defines an at least partial hemispherical surface, where the second aperture defines a conical aperture. Alternatively, the first surface defines an at least partial half-cylindrical surface, where the first aperture defines an substantially parallel-walled slot, i.e., at least the two walls along the length of the slot are substantially parallel.

In some embodiments where the first surface defines an at least partial hemispherical surface and the second surface defines an at least partial half-cylindrical surface, the center of a sphere that defines the hemispherical surface is located closer to the at least partial half-cylindrical surface than a centerline of a cylinder that defines the half-cylindrical surface. The radii of the sphere and the cylinder may be substantially identical.

The first component may also define a hole in the first component at a side of the first aperture remote from the connector. Also, the second component may further define a hole in the second component at a side of the second aperture remote from the connector. The connector may also include at least one projection extending therefrom. The at least one projection is configured to be received within the first hole, the second hole, or both the first and the second holes.

According to the invention there is also provided a method for aligning the first and second components with one another using three connectors each having projections extending therefrom. The first surface of each connector is placed into contact with a respective cavity using a projection to compliantly self-align and retain each connector with a respective cavity. Similarly, the second surface of each connector is placed into contact with a respective groove using a projection to align each connector with a respective groove. The first and second components are then pressed toward one another such that each first surface is press-fit within a respective cavity. The first component is then separated from the second component and the projections removed from the connectors. The first and second components may then be reassembled such that the second surfaces of the connectors align in respective grooves. Thereafter, despite repeated disassembly and reassembly the components remain in identical positions when reassembled.

The above described embodiments generate a very high stiffness in all directions, i.e., have a full kinematic geometry. The above described embodiments are also simple and inexpensive to manufacture through mass-production and provide an easy mechanism for repeated and accurate assembly and alignment of components.

### BRIEF DESCRIPTION OF THE DRAWINGS

For a better understanding of the nature and objects of the invention, reference should be made to the following detailed description, taken in conjunction with the accompanying drawings, in which:

FIG. 1 is an isometric view of an engine block and bedplate utilizing a kinematic mounting system, according to an embodiment of the invention;

FIG. 2 is a bottom view of the engine block and bedplate of FIG. 1;

FIG. 3 is an isometric view of a connector of the kinematic mounting system shown in FIG. 1;

FIG. 4 is a partial cross-sectional view of a connector in position between an engine block and bedplate;

FIGS. 5A-5C are different embodiments of a connector, according to different embodiments of the invention;

FIG. 6 is a flow-chart of a method for assembling two components using a kinematic mounting system, according to an embodiment of the invention; and

FIG. 7 is a partial cross-sectional view of another connector in position between an engine block and bedplate.

Like reference numerals refer to corresponding parts throughout the several views of the drawings. For ease of reference, the first number of any reference numeral generally indicates the Figure number in which the reference numeral can be found.

### DETAILED DESCRIPTION OF PREFERRED EMBODIMENTS

The kinematic mounting system is used to repeatedly align and removably couple two components together, such as an engine block and bedplate, in an identical relative position as when previously aligned and coupled. In some embodiments, the kinematic mounting system applies six constraints against the three translational and three rotational degrees of freedom utilizing one face and 6 line contacts and thus reduces stress between a connector and the components. This increases the load capacity and the mechanical stiffness of the kinematic mounting system while reducing wear and failure.

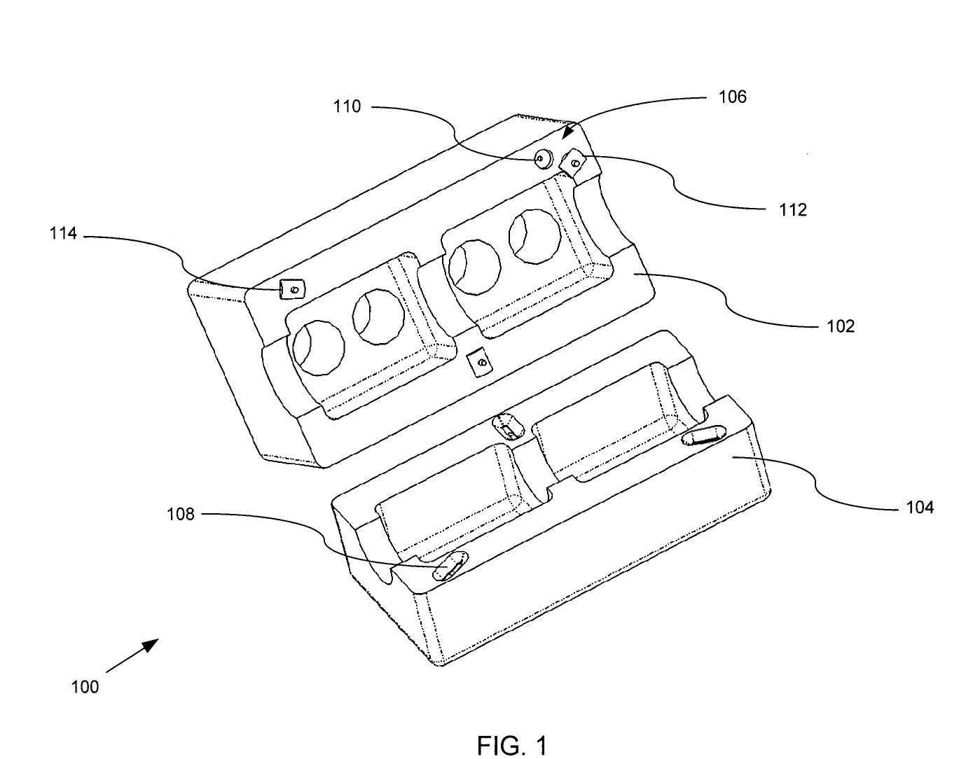

FIG. 1 is an isometric view of an engine block 102 and bedplate 104 utilizing one embodiment of a kinematic mounting system. The engine block and bedplate are components of a combustion engine that may be disassembled and reassembled multiple times during the lifetime of the engine. For example, during manufacture, the block and bedplate of an engine are typically disassembled and reassembled multiple times to enable machining of bearing seats, machining of the bearings themselves, and insertion of the crankshaft. Furthermore, high-performance engines used in racing cars or boats are often disassembled and rebuilt to maintain the engine and adjust engine performance.

Most of the engine components, such as the engine block, bedplate, pistons, valves or the like, all have very tight tolerances and, therefore, require precise alignment. Accordingly, it is imperative that the engine block and bedplate are accurately aligned with one another prior to any machining and subsequent reassembly.

In some embodiments, the kinematic mounting system includes three kinematic mounts 106. Each kinematic mount 106 includes a groove 108 in the bedplate 104, a cavity 110 in the block 102, and a connector 112. The connector 112 is configured to mate with the groove 108 and be press-fit within the cavity 110. By press-fit it is meant that the first surface of the connector will always interfere with the cavity when assembled because the first surface is larger than the cavity. The resulting difference in sizes, also called the allowance, means that force is required to assemble the part. A press-fit fixes or anchors the connector to the first component as if they were one body. A press-fit is also known as an interference-fit or shrink-fit. In some embodiments, the press or interference-fit requires a hydraulic press to couple the connector to the first component.

In an alternative embodiment, the groove 108 may be formed in the block 102 and the cavity 110 in the bedplate 104. Also, in some embodiments, the sides of the block and the bedplate that face one another when assembled are substantially flat to form a sealed contact with one another. Also in some embodiments, the faces of the two components in contact with one another provide one constraint against one degree of freedom. For example, the engine block and engine bedplate components of a combustion engine maintain a tight contact in their interface, thereby restricting movement along one axis.

When assembled, the kinematic mounting system includes the following components: a first component, such as the engine block 102; a second component 104, such as the engine bedplate 104; and three connectors 112 used to repeatedly align the first component and the second component relative to one another.

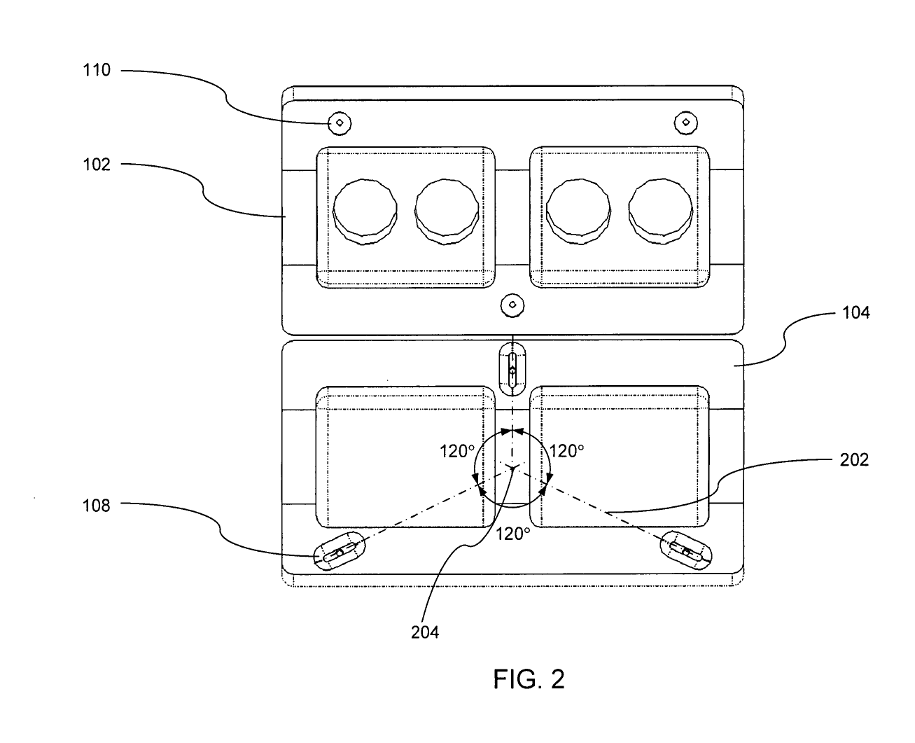

FIG. 2 is a bottom view of the engine block 102 and bedplate 104, according to the embodiment shown in FIG. 1. This figure shows a spatial relationship of the grooves 108 to one another, and a spatial relationship of the cavities 110 to one another. In some embodiments, the cavities 110 are disposed at the apexes of an equilateral triangle, i.e., disposed approximately 120 degrees apart from one another. Also, in some embodiments, the three grooves 108 extend along longitudinal axes 202 toward a central point 204. In these embodiments, the longitudinal axes of the grooves 108 may be disposed at approximately 120 degrees apart from one another, as shown.

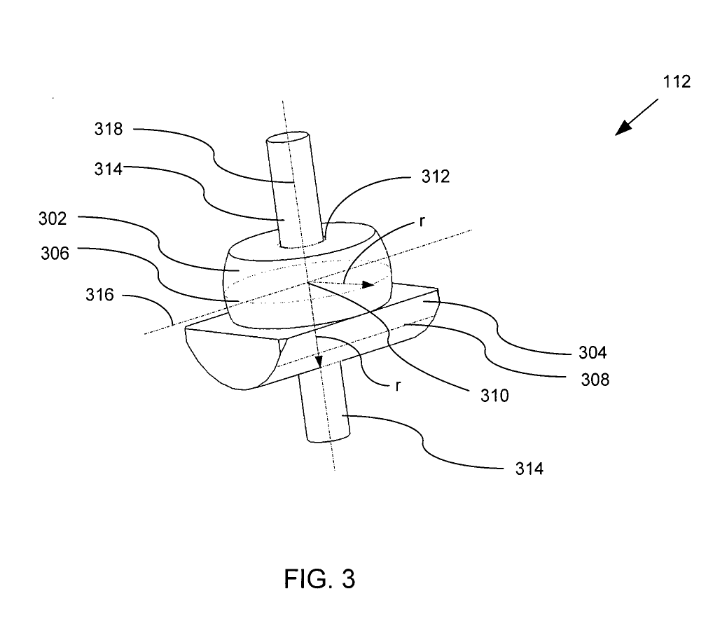

FIG. 3 is an isometric view of the connector 112 of the kinematic mounting system described above. Each connector 112 comprises a first surface 302 and a second surface 304. The first surface 302 forms an interference-fit or press-fit with the first component within a respective cavity 110 (FIG. 1). The second surface 304 contacts a respective groove 108 (FIG. 1) along two contact lines 308 between the connector 112 and the respective groove 108 (FIG. 1). In some embodiments, the contact lines 308 are substantially parallel to one another.

In some embodiments, the first surface 302 defines an at least partial hemispherical surface and the second surface 304 defines an at least partial half-cylindrical (or hemicylindrical) surface. In other words, the hemispherical surface may be a full hemisphere, a frusto-hemisphere, or the like. Similarly, the half-cylinder may be full half-cylinder, a frusto-half-cylinder, or the like. Stated differently, “at least partial” means that the surface may be less or more than the defined shape, e.g., an at least partial hemispherical surface may be less or more than a full hemispherical surface.

During assembly, because of imperfections in fabrication, a disruptive moment might develop that would tend to rotate the connector about the cylinder axis and bring a shoulder of the at least partial half-cylindrical surface into contact with a bottom plane of the engine block. Such contact might degrade the accuracy of the mount. Therefore, to counteract such tendencies, the center of the first surface may be substantially in a plane perpendicular to a separating plane (between the first and second surfaces) and passing through the second surfaces axis. In some embodiments, the center of the first surface is located closer to the second surface than the center of the second surface to offer a restoring torque moment on assembly. For example, where the first surface defines an at least partial hemispherical surface and the second surface defines an at least partial half-cylindrical surface, the center 310 of a sphere that defines the hemispherical surface is located closer to the at least partial half-cylindrical surface than a centerline 316 of a cylinder that defines the half-cylindrical surface. The radii of the sphere and the cylinder may be substantially identical. Also, in some embodiments, the radius “r” of the at least partial hemispherical surface about the center 310 is substantially the same as the radius “r” of the at least partial half-cylindrical surface about the centerline 316.

In some embodiments, projections 314 extend from the first surface 302 and the second surface 304. The projections 314 are used to temporarily and compliantly align and retain the connector 112 in position and attitude while lowering the block onto the bedplate, or vice versa. In some embodiments, the projections 314 extend substantially perpendicular to the axis 316 and substantially collinear with the axis 318.

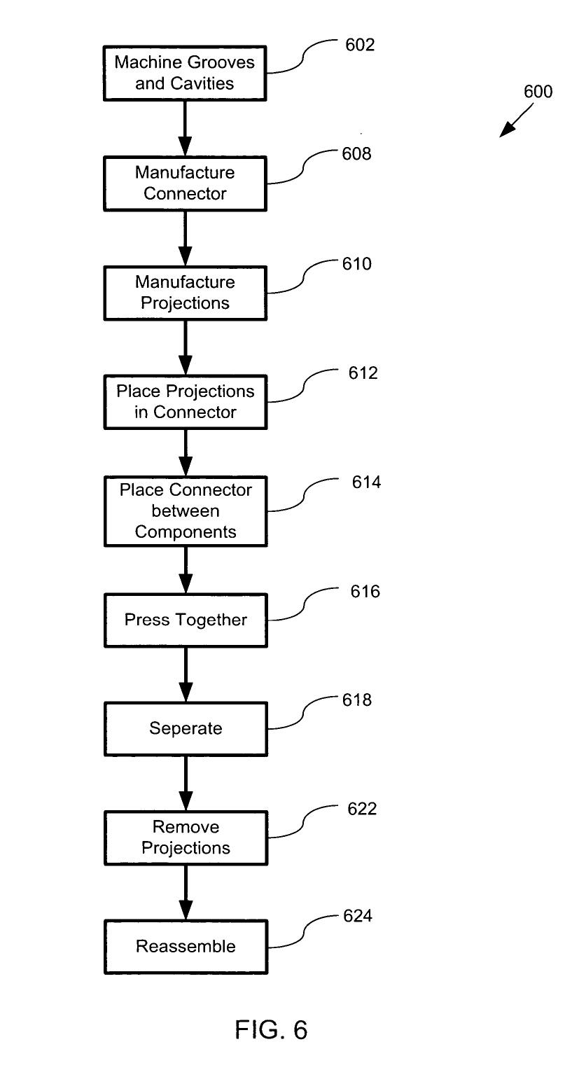

More specifically, in some embodiments, the projections 314 are removable rubber cords that pass through a bore 312 formed through the connector 112 collinear with the longitudinal axis 316, e.g., extend through an apex of the first surface 302 and an apex of the second surface 304. In this embodiment, the bore 312 has a diameter slightly smaller than the diameter of the projections passing through it. Further details of the method of assembly are described below with reference to FIG. 6.

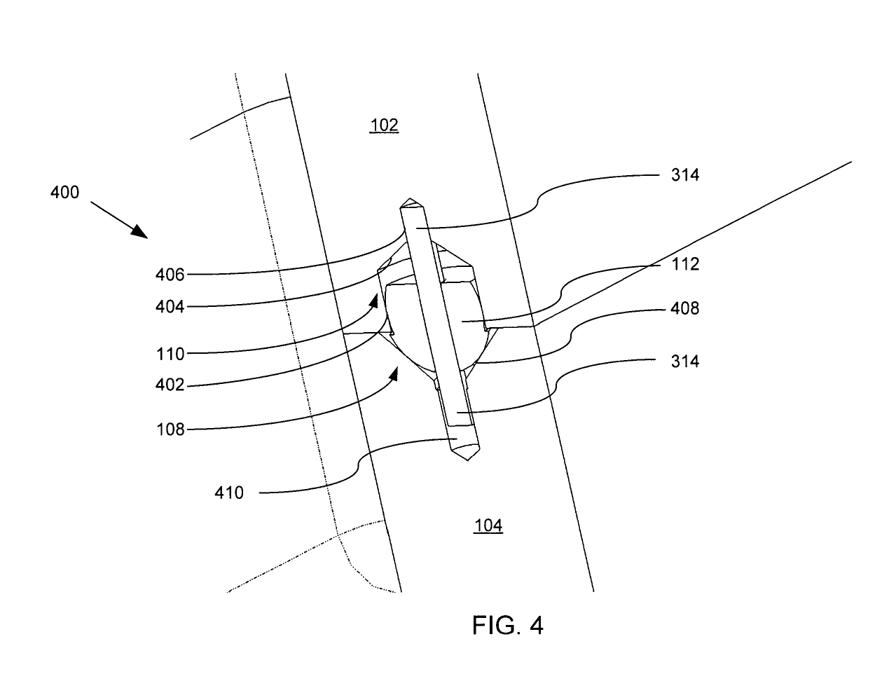

FIG. 4 is a partial cross-sectional view of a connector 112 in position in the cavity 110 defined by the engine block 102 and in the groove 108 defined by the engine bedplate 104. In some embodiments, each cavity 110 comprises three portions extending substantially perpendicular to a wall or side of the first component (e.g., the block 102), namely: a cylindrical cavity 402 that extends from an opening in the wall or side of the component; a frusto conical (conical frustum) cavity 404 that extends from the cylindrical cavity 402; and a hole 406 that extends from the frusto conical cavity 404. The hole 406 may be tapered at the end thereof, and may be configured to tightly receive one of the projections 314 therein. In an alternative embodiment, each cavity 110 may have any suitable shape(s), as long as the connector and cavity behave as described below.

The cavity 110, or cylindrical cavity 402, is configured and dimensioned such that the first surface 302 of the connector 112 can be interference-fit or press-fit into the cavity. This is an important feature of this embodiment, as (1) it allows the connector to be retained in position within the cavity 110 when the two components are separated from one another, and (2) causes the connector and the first component to behave as a single component. This simplifies subsequent disassembly and reassembly. In some embodiments, he interference-fit plastically deforms both the first surface of a connector and the wall of a respective cavity.

In some embodiments, each groove 108 comprises two portions extending substantially perpendicular to a wall or side of the second component (e.g., the bedplate 104), namely: a frusto-conical (conical frustum) prism 408 that extends from the wall or side of the second component; and a hole 410 that extends from the frusto-conical prism 408. The hole 406 may be tapered at the end thereof and configured to receive a projection 314 therein. This allows a projection to be located in a hole, when the components are pressed together. In an alternative embodiment, each groove 108 may have any suitable shape(s), as long as the connector 112 contacts the groove along two substantially parallel contact lines, as described above.

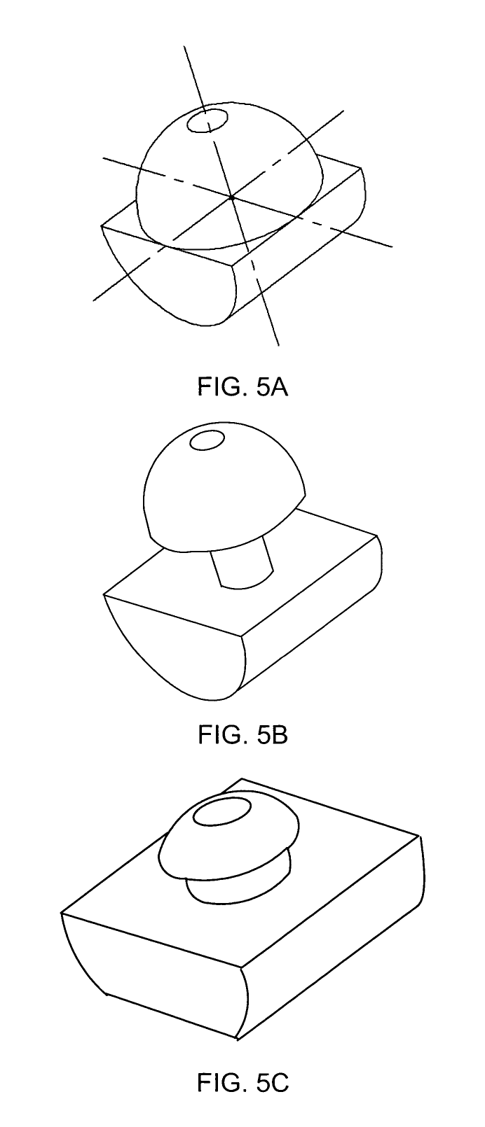

FIGS. 5A-5C are different embodiments of a connector, according to different embodiments of the invention. FIG. 5A shows a connector having a hemispherical first surface and a half-cylindrical second surface. FIG. 5B shows a connector having a partial hemispherical first surface coupled to a half-cylindrical second surface by means of a post. FIG. 5C shows a connector having a partial hemispherical first surface coupled to a frusto-half-cylindrical second surface via a post.

FIG. 6 is a flow-chart 600 of a method for aligning two components with one another, such as the engine block 102 (FIG. 1) and bedplate 104 (FIG. 1), using a kinematic mounting system, according to an embodiment of the invention. Initially, at step 602, cavities 110 (FIG. 1) and holes 406 (FIG. 4) and 404 (FIG. 4) are formed in the first component, and grooves 108 (FIG. 1) are formed in the second component, such as by machining the block and bedplate. Connectors are then manufactured, at step 608. The projections 314 (FIG. 3), such as the rubber cords, are manufactured at step 610. The projections are then placed through the bore in the connector at step 612. The projections may be made from an elastic material, such as rubber, that elastically deforms when forced through the bore.

The connectors are then positioned into contact with a respective cavity, where each projection is forced into a hole at the rear of the cavity to temporarily align and retain the connecter to the first component. The two components are then pressed together at step 616. This generally requires a hydraulic press that supplies a force that depends on the size of the components and connectors. For example, the embodiment described above in relation to FIG. 1-5 may require a force of between 1000-1500 pounds force. The force supplied by the hydraulic press should be sufficient to force the first surface of the connector into the cavity, but should not be large enough to plastically deform the connector or the second component within the grooves. Accordingly, this causes the first surface of each connector to be press-fit within a respective cavity. The components are then separated, at step 618, and the projections removed from the connectors at step 622. The two components may then be reassembled at step 624. Thereafter, whenever the engine is reassembled a true kinematic mount exists to align the block and bedplate with one another.

The above described embodiments distributes applied loads, reduce the build-up of point stresses that form at point contacts, and increases stability and stiffness and, therefore, repeatability under higher loads of the kinematic mount, while reducing stress and wear.

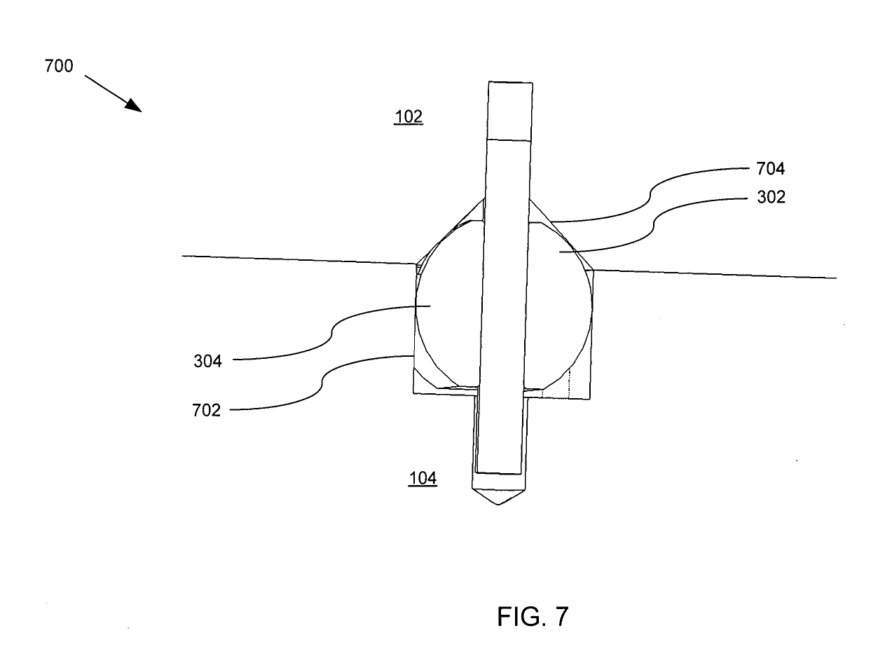

FIG. 7 is a partial cross-sectional view 700 of another connector in position between an engine block 102 and bedplate 104. In this embodiment, each at least partial half-cylindrical surface 304 is press-fit within a respective parallel-walled slot 702 formed in the second component, while each at least partial hemispherical surface 302 contacts the first component along an annular line in a respective conical recess 704 formed in the first component.

The foregoing descriptions of specific embodiments of the present invention are presented for purposes of illustration and description. They are not intended to be exhaustive or to limit the invention to the precise forms disclosed. Obviously many modifications and variations are possible in view of the above teachings. For example, the first surface and second surface may take on any suitable shape. Also, the various components described above are preferably made of a hard material, such as stainless steel. Alternatively, any suitable material may be used. Furthermore, although the above description is directed to a kinematic mounting system used to align an engine block and bedplate, it should be appreciated that the kinematic mounting system may be used to align any two components or bodies with one another. Also, although the first component is described as defining the cavities and the second component is described at defining the grooves, these combinations may be switched, in which case the connectors will need to be inverted prior to assembly.

The embodiments were chosen and described above in order to best explain the principles of the invention and its practical applications, to thereby enable others skilled in the art to best utilize the invention and various embodiments with various modifications as are suited to the particular use contemplated. Furthermore, the order of steps in the method are not necessarily intended to occur in the sequence laid out. It is intended that the scope of the invention be defined by the following claims and their equivalents. In addition, any references cited above are incorporated herein by reference.

What is claimed is:

1. A kinematic mounting system for repeatedly coupling two components together, said kinematic mounting system comprising:
a first component defining at least one first aperture therein;
a second component defining at least one second aperture therein; and
at least one connector comprising:
a first surface press-fit within said first aperture defined by said first component; and
a second surface coupled to and substantially opposing said first surface, where said second surface contacts said second component within said second aperture along at least one contact line.

2. The kinematic mounting system of claim 1, wherein said second surface contacts said second component within said second aperture along at least two substantially parallel contact lines.

3. The kinematic mounting system of claim 1, wherein said second surface contacts said second component within said second aperture along an annular contact line.

4. The kinematic mounting system of claim 1, wherein said second surface contacts said second component within said second aperture only along said at least one contact line.

5. The kinematic mounting system of claim 1, wherein said first surface defines an at least partial hemispherical surface, and said first aperture is an at least partially cylindrical cavity.

6. The kinematic mounting system of claim 1, wherein said second surface defines an at least partial half-cylindrical surface, and said second aperture is an at least partially a frusto-triangular prism groove.

7. The kinematic mounting system of claim 1, wherein said second surface defines an at least partial hemispherical surface, and said second aperture defines a conical aperture.

8. The kinematic mounting system of claim 1, wherein said first surface defines an at least partial half-cylindrical surface, and said first aperture defines a substantially parallel-walled slot.

9. The kinematic mounting system of claim 1, wherein said first component is an engine block and said second component is an engine bedplate.

10. The kinematic mounting system of claim 1, wherein said first component is an engine bedplate and said second component is an engine block.

11. The kinematic mounting system of claim 1, wherein said first component further defines a hole in said first component at a side of said first component remote from said connector.

12. The kinematic mounting system of claim 1, wherein said second component further defines a hole in said second component at a side of said second aperture remote from said connector.

13. The kinematic mounting system of claim 1, wherein said first component further defines a first hole in said first component at a side of said first aperture remote from said connector, and said second component further defines a second hole in said second component at a side of said second aperture remote from said connector.

14. The kinematic mounting system of claim 13, wherein said connector further comprises at least one projection extending therefrom, wherein said at least one projection is configured to be received within said first hole, said second hole, or both said first and said second holes.

15. The kinematic mounting system of claim 14, wherein said projection is a rubber cord.

16. The kinematic mounting system of claim 14, wherein said at least one projection is removable from said connector.

17. The kinematic mounting system of claim 1, further comprising multiple first apertures, second apertures and connectors.

18. The kinematic mounting system of claim 1, wherein said first surface defines an at least partial hemispherical surface and said second surface defines an at least partial half-cylindrical surface, wherein a center of a sphere that defines said hemispherical surface is located closer to said at least partial half-cylindrical surface than a centerline of a cylinder that defines said half-cylindrical surface.

19. The kinematic mounting system of claim 18, wherein radii of said sphere and said cylinder are substantially identical.

20. A kinematic mounting system for repeatedly coupling two components together, said kinematic mounting system comprising:
a first surface configured to be press-fit within a first aperture defined by a first component; and
a second surface coupled to and substantially opposing said first surface, where said second surface is configured to contact said second component at a second aperture along at least one contact line.

21. The kinematic mounting system of claim 20, wherein said second surface contacts said second component at said second aperture along at least two substantially parallel contact lines.

22. The kinematic mounting system of claim 20, wherein said second surface contacts said second component at said second aperture along an annular contact line.

23. The kinematic mounting system of claim 20, wherein said second surface contacts said second component at said second aperture only along said at least one contact line.

24. The kinematic mounting system of claim 20, wherein said first surface defines an at least partial hemispherical surface, and said first aperture is an at least partially cylindrical cavity.

25. The kinematic mounting system of claim 20, wherein said second surface defines an at least partial half-cylindrical surface, and said second aperture is an at least partially a frusto-triangular prism groove.

26. The kinematic mounting system of claim 20, wherein said second surface defines an at least partial hemispherical surface, and said second aperture defines a conical aperture.

27. The kinematic mounting system of claim 20, wherein said first surface defines an at least partial half-cylindrical surface, and said first aperture defines an substantially parallel-walled slot.

28. A kinematic mounting system for repeatedly coupling two components together, said kinematic mounting system comprising:
a first component defining three substantially cylindrical cavities therein;
a second component defining three grooves therein; and
three connectors, each comprising:
an at least partial hemispherical first surface press-fit within a respective one of said cavities;
an at least partial half-cylindrical second surface coupled to and substantially opposing said first surface, wherein said second surface contacts a respective one of said grooves along two substantially parallel lines.

29. A kinematic mounting system for repeatedly coupling two components together, said kinematic mounting system comprising:
a first component defining three substantially conical cavities therein;
a second component defining three substantially parallel-walled slots therein; and
three connectors, each comprising:
an at least partial hemispherical first surface contacting a respective one of said cavities along a substantially annular contact line; and
an at least partial half-cylindrical second surface coupled to and substantially opposing said first surface, wherein said second surface is press-fit within a respective one of said slots.

30. A kinematic mounting system for repeatedly coupling two components together, said kinematic mounting system comprising:
three connectors, each comprising:
an at least partial hemispherical first surface configured to be press-fit within a respective one of three cylindrical cavities defined in a first component;
an at least partial half-cylindrical second surface coupled to and substantially opposing said first surface, wherein said second surface is configured to contact a respective one of three grooves, defined in a second component, along two substantially parallel lines.

31. A kinematic mounting system for repeatedly coupling two components together, said kinematic mounting system comprising:
three connectors, each comprising:
an at least partial hemispherical first surface configured to contact a respective one of three conical cavities, defined in a first component, along a substantially annular contact line;
an at least partial half-cylindrical second surface coupled to and substantially opposing said first surface, wherein said second surface is configured to be press-fit within a respective one of three substantially parallel-walled slots defined in a second component.

32. A kinematic mounting system for repeatedly coupling two components together, said kinematic mounting system comprising:
a first component defining three substantially cylindrical cavities each having a respective first hole connected thereto;
a second component defining three grooves therein each having a respective second hole connected thereto; and
three connectors, each comprising:
an at least partial hemispherical first surface configured to press-fit within a respective one of said cavities;
an at least partial half-cylindrical second surface coupled to said first surface, wherein said second surface is configured to contact a respective one of said grooves; and
projections extending from said connector, where each of said projections are configured to be received within at least one of said first or second holes.

33. A method for aligning first and second components with one another using three connectors each having projections extending therefrom, where the first component defines three substantially cylindrical cavities each having a respective first hole connected thereto, the second component defines three grooves therein each having a respective second hole connected thereto, and the three connectors each include an at least partial hemispherical first surface coupled to an at least partially cylindrical second surface, said method comprising:
placing the first surface of each connector into contact with a respective cavity using a projection to compliantly align each connector with a respective cavity;
placing the second surface of each connector into contact with a respective groove using a projection to align each connector with a respective groove;
pressing the first and second components toward one another until their interface forms a tight contact, such that each first surface is press-fit within a respective cavity;
separating the first component from the second component;
removing the projections from the connectors;
reassembling the first and second components such that the second surfaces of the connectors align in respective grooves.
